(19) United States
(12) Patent Application Publication
(10) Pub. No.: US 2025/0070618 A1
(43) Pub. Date: Feb. 27, 2025

(54) MOTOR

(71) Applicant: JIANGSU DONGCHENG TOOLS TECHNOLOGY CO., LTD, Nantong (CN)

(72) Inventor: Tianliang LIU, Nantong (CN)

(21) Appl. No.: 18/724,639

(22) PCT Filed: Dec. 26, 2022
(86) PCT No.: PCT/CN2022/142012

§ 371 Date: Jun. 27, 2024

(30) Foreign Application Priority Data
Jul. 29, 2022 (CN) 202210910518.3

(51) Int. Cl. H02K 9/06; B25F 5/00; B25F 5/02; H02K 7/14; H02K 21/16

(52) U.S. Cl. CPC H02K 9/06; B25F 5/008; B25F 5/02; H02K 7/145; H02K 21/16

(57) ABSTRACT

The present disclosure relates to a motor. The motor includes a shaft extending in an axial direction, an inner rotor fixed on the shaft, an outer stator sleeved on the inner rotor, and a fan on the shaft. The fan can rotate with the shaft to generate airflow to cool the outer stator. The motor further includes an air-guiding cover including a first air-guiding ring and a second air-guiding ring arranged along the axial direction. The first air-guiding ring is located between the outer stator and the second air-guiding ring. The fan is located within the second air-guiding ring. The first air-guiding ring has an inner diameter d3, the outer stator has a first inner diameter d1, and the inner diameter d3 is greater than or equal to the first inner diameter d1. The heat dissipation effect is significantly improved.

### TECHNICAL FIELD

The present disclosure relates to a motor, particularly relates to a motor with an air-guiding cover.

### BACKGROUND

The air-guiding plate used in a traditional AC or DC power tool fans can guide airflow into the fan inlet at some extent, but cannot reasonably distribute motor heat dissipation flow to an air gap and a stator casing channel, which can easily cause uneven cooling of the outer stator, the coil, and rotor, resulting in local high temperatures. For DC tools, the machine frequently protects due to over temperature.

In addition, for the structure of the air-guiding cover, prior art does not disclose optimal structural dimensions for motor heat dissipation, fan power consumption, etc., nor has disclosed relationships between an inner diameter of the air-guiding cover, a distance from the coil, the rotor diameter, the inner and outer diameters of the outer stator, and the system heat dissipation.

Therefore, it is indeed necessary to provide an improved motor to overcome shortcomings of the prior art.

### SUMMARY

In view of the shortcomings of the prior art, the purpose of the present disclosure is to provide a motor having improved heat dissipation performance.

The present disclosure can solve existing technical problems by adopting the following technical solutions: a motor includes a shaft extending axially, an inner rotor fixed on the shaft, an outer stator sleeved on an outer circumference of the inner rotor, and a fan set on the shaft. The fan is located at an axial front end of the outer stator and rotates with the shaft to generate airflow to cool the outer stator. The motor further includes an air-guiding cover located between the outer stator and the fan. The air-guiding cover comprises a first air-guiding ring located at an axial rear end and a second air-guiding ring located at an axial front end. The fan is located within the second air-guiding ring, and the first air-guiding ring is adjacent to the outer stator and has an inner diameter d3 of the first air-guiding ring, the outer stator has a first inner diameter d1, and the inner diameter d3 of the first air-guiding ring is greater than or equal to the first inner diameter d1 of the outer stator.

A further improvement is as follows: the fan includes a hub driven by the shaft and a plurality of blades radially protruding outward from a peripheral edge of the hub; the hub has a hub diameter d5, the inner rotor has a rotor outer diameter d0, the hub diameter d5 is less than or equal to the rotor outer diameter d0.

A further improvement is as follows: the second air-guiding ring has an axial height h2, the blade has a blade height h3, and the axial height h2 of the second air-guiding ring is greater than or equal to the blade height h3 of the blade.

A further improvement is as follows: the fan has a fan diameter d6, and a ratio of the hub diameter d5 to the fan diameter d6 is less than or equal to 0.5, and a ratio of the hub diameter d5 to the fan diameter d6 is greater than or equal to 0.2.

A further improvement is as follows: the air-guiding cover comprises an air-guiding plate located between the first air-guiding ring and the second air-guiding ring, and the air-guiding plate defines a first opening for the shaft to pass through; the first opening has an inner diameter d4 of the air-guiding plate, wherein a relationship between the inner diameter d4 of the air-guiding plate, the diameter d5 of the hub, and the diameter d6 of the fan follows following formula: 0.5(d5+d6)≤d4≤d6.

A further improvement is as follows: the first air-guiding ring has an axial height h1, and a ratio of the axial height h1 of the first air-guiding ring to the inner diameter d4 of the air-guiding plate is less than or equal to 0.5 and greater than or equal to 0.1.

A further improvement is as follows: the second air-guiding ring has an inner diameter d7 of the second air-guiding ring, wherein a relationship between the inner diameter d7 of the second air-guiding ring, the fan diameter d6, and the inner diameter d4 of the air-guiding plate follows following formula: d7≥2d6−d7.

A further improvement is as follows: the air-guiding cover comprises an extended edge that protrudes outward along a circumference of the air-guiding plate on an inner side of the second air-guiding ring, and the extended edge is provided with a protrusion perpendicular to the second air-guiding ring.

A further improvement is as follows: the motor further comprises an end plate located on an end side of the motor, wherein the inner side of the first air-guiding ring is arc-shaped and an outer edge of the first air-guiding ring abuts against the end plate, and the first air-guiding ring also has a first volute portion to conduct air flow.

A further improvement is as follows: the second air-guiding ring has a second volute portion that accommodates the fan and a second opening located in the circumferential direction of the second air-guiding ring, the second opening is used to conduct airflow.

Compared with the prior art, the present disclosure has one or more of the following beneficial effects.

1. By providing an air-guiding cover on the motor, the air-guiding cover includes a first air-guiding ring and a second air-guiding ring. The first air-guiding ring and the second air-guiding ring are hollow and define openings on two sides. The first air-guiding ring has an inner diameter d3, the outer stator has a first inner diameter d1, the inner diameter d3 of the first air-guiding ring is set to be greater than or equal to the inner diameter d1 of the outer stator, airflow between the air-guiding ring and the casing is not easy to enter, the heat dissipation effect is good, and the airflow through the fan can be increased by at least 10%.

2. When the hub diameter d5 is less than or equal to the rotor outer diameter d0, the airflow between the outer stator and the rotor can completely enter the fan. Compared with the hub diameter d5 is larger than the rotor outer diameter d0, the heat dissipation effect is good and can be increased by 5% of motor heat dissipation flow.

3. The axial height h2 of the second air-guiding ring is greater than or equal to the blade height h3 to ensure that the blades are completely located in the second volute portion of the second air-guiding ring, which is beneficial to controlling direction of the airflow and has a good heat dissipation effect.

4. When the fan has a fan diameter d6, the ratio of the hub diameter d5 to the fan diameter d6 is less than or equal to 0.5, and the ratio of the hub diameter d5 to the fan diameter d6 is greater than or equal to 0.2, it is not easy to form vortex areas at the fan blades, and the heat dissipation effect is good, which can increase the motor heat dissipation flow by more than 5%.

5. The inner diameter d4 of the air-guiding plate is greater than or equal to one-half of the sum of the hub diameter d5 and the fan diameter d6, and the inner diameter d4 of the air-guiding plate is less than or equal to the fan diameter d6, the heat dissipation effect is good, it can significantly increase the motor heat dissipation flow by more than 10%.

6. The first air-guiding ring has an axial height h1. The ratio of the axial height h1 of the first air-guiding ring to the inner diameter d4 of the air-guiding plate is less than or equal to 0.5 and greater than 0.1. The heat dissipation effect is good and relatively good, and the motor heat dissipation flow can be increased by more than 5% compared to if the ratio is not within the range.

7. The second air-guiding ring has an inner diameter d7. The inner diameter d7 of the second air-guiding ring is greater than or equal to a difference between twice of the fan diameter d6 minus the inner diameter d4 of the air-guiding plate. The heat dissipation effect is good and relatively good. Compared with the inner diameter d7 of the second air-guiding ring, which is less than the difference between twice of the fan diameter d6 minus the inner diameter d4 of the air-guiding plate, the heat dissipation flow rate of the motor can increase by at least 10%, and the winding temperature rise can reduce by more than 2° C.

8. Compared to the inner side in a right angle shape, the inner side of the first air-guiding ring is in a circular arc shape, which can prevent the airflow on the inlet side from directly colliding with the air-guiding plate of the air-guiding cover, causing a loss of airflow velocity, and can improve the heat dissipation effect.

### BRIEF DESCRIPTION OF THE DRAWINGS

The following will provide a further detailed explanation of the specific embodiments of the present disclosure in conjunction with the accompanying drawings.

FIG. 1 is a cross-sectional view of a motor of the present disclosure applied in a power tool.

FIG. 2 is a three-dimensional schematic view of the motor of a first embodiment of the present disclosure.

FIG. 3 is an exploded view of the motor shown in FIG. 2.

FIG. 4 is a cross-sectional view of the air-guiding cover of the motor shown in FIG. 2.

FIG. 5 is a three-dimensional schematic view of the air-guiding cover of the motor of the second embodiment of the present disclosure.

FIG. 6 is a cross-sectional view of the motor shown in FIG. 2.

FIG. 7 is a schematic view of a first inner diameter d1 and a second inner diameter d2 of an outer stator in the motor shown in FIG. 6.

FIG. 8 is a schematic view of d3 of the air-guiding cover in the motor shown in FIG. 6.

FIG. 9 is a schematic view of a hub ratio of a fan shown in FIG. 6.

Meanings of accompanying symbols in the Fig.:

| | | |
|---|---|---|
| 100: Motor | 10: shaft | 20: inner rotor |
| 30: outer stator | 31: stator core | 32: winding |
| 40: air-guiding cover | 41: first air-guiding ring | 411: first volute portion |
| 42: second air-guiding ring | 421: second volute portion | 43: air-guiding plate |
| 431: first opening | 44: second opening | 45: extended edge |
| 451: protrusion | 50: fan | 51: hub |
| 52: blade | 60: end plate | 70: battery pack |
| 80: casing | 90: circuit board | d0: rotor outer diameter |
| d1: stator first inner diameter | d2: stator second inner diameter | d3: first air-guiding ring inner diameter |
| d4: inner diameter of air-guiding plate | d5: hub diameter | d6: fan diameter |
| d7: inner diameter h1 of the second air-guiding ring | h1: axial height of the first air-guiding ring | |
| h2: axial height of the second air-guiding ring | h3: blade height | |

### DETAILED DESCRIPTION

Following is a further detailed explanation of the present disclosure in conjunction with the accompanying drawings and implementation methods.

The terms used in this disclosure are solely for a purpose of describing specific embodiments and are not intended to limit the present disclosure. For example, the following words such as “up”, “down”, “front”, “back”, “left”, “right” indicating orientation or positional relationships are only based on orientation or positional relationships shown in the drawings, and are only for the convenience of describing the present disclosure and simplifying the description, rather than indicating or implying that the device/component referred to must have a specific orientation or be constructed and operated in a specific orientation. Therefore, it cannot be understood as a limitation of the present disclosure.

In the description of the present disclosure, it should be noted that unless otherwise specified and limited, the terms “install”, “connect”, and “couple” should be broadly understood, for example, it can be fixed connection, detachable connection, or integrated connection. It can be mechanical connection or electrical connection. It can be directly connection, or indirectly connection by an intermediate medium, or it can be an internal connection between two components. For ordinary people skilled in this field, the specific meanings of the above terms in the present disclosure can be understood in specific situations.

In this disclosure, all features defined in a form of a range or a percentage range, such as numerical values, quantities, and ratios, are for simplicity and convenience only. Based on this, the description of the numerical range or percentage range should be considered as covering and specifically disclosing all possible secondary ranges and individual values within the range (including integers and fractions), especially integer values. For example, the range of “1 to 8” should be considered as having been specifically disclosed for all secondary ranges such as 1 to 7, 2 to 8, 2 to 6, 3 to 6, 4 to 8, 3 to 8, etc., especially for secondary ranges defined by integer values, and should be considered as having been specifically disclosed for individual values such as 1, 2, 3, 4, 5, 6, 7, 8, etc. Unless otherwise specified, aforementioned interpretation methods can be applied to all aspects of the present disclosure, regardless of whether the scope is extensive or not.

If the quantity or other numerical values or parameters are expressed in terms of range, preferred range, or a series of an upper and a lower limit, it should be understood that this disclosure has specifically disclosed all ranges composed of any pair of upper limits or preferred values of that range and the lower limits or preferred values of that range, regardless of whether these ranges have been disclosed separately. In addition, if the range of values is mentioned in this disclosure, unless otherwise specified, the range should include endpoint value and all integers and fractions within the range.

In this disclosure, the numerical value should be understood as having an accuracy of the number of significant digits of the numerical value under a premise of achieving the purpose of the disclosure. For example, the number 40.0 should be understood as covering a range of 39.50 to 40.49.

In addition, the technical features involved in the different embodiments of the present disclosure described below can be combined with each other as long as they do not conflict with each other.

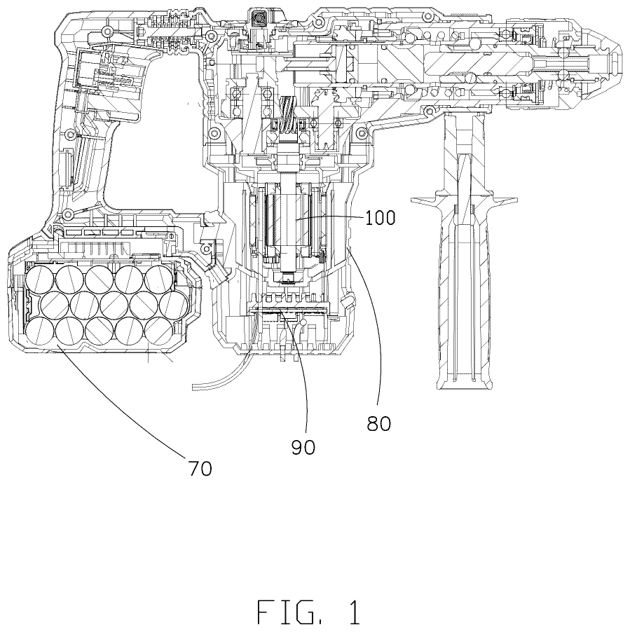

Please refer to FIG. 1, the embodiment of the present disclosure relates to an electric motor 100 applied to a power tool, including but not limited to an electric hammer, angle grinder, or curve saw, providing power for the power tool. In the present disclosure, the power tool preferably to be an electric hammer, which is a portable DC electric hammer capable of installing a battery pack 70, and the battery pack 70 can be installed at the bottom of the handle by a battery pack installation guiding rail. A circuit board 90 that controls an operation of the electric hammer is located at a bottom of a casing 80, and is respectively electrically connected to the motor 100, a battery pack 70, a switch, etc. By using an air-guiding cover on the motor of the present disclosure, ventilation conditions of the motor and the power tool can be improved, temperature rise of the motor and power tools can be effectively reduced, and the heat dissipation effect can be improved.

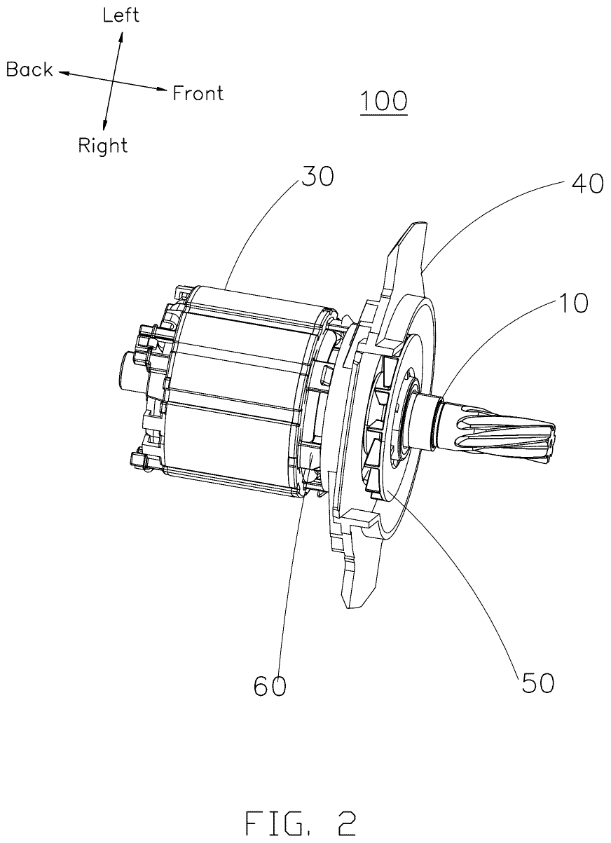

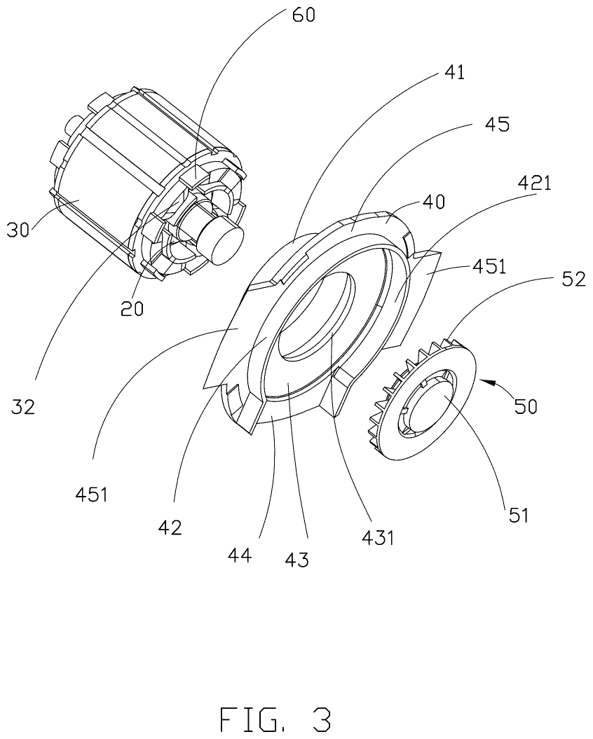

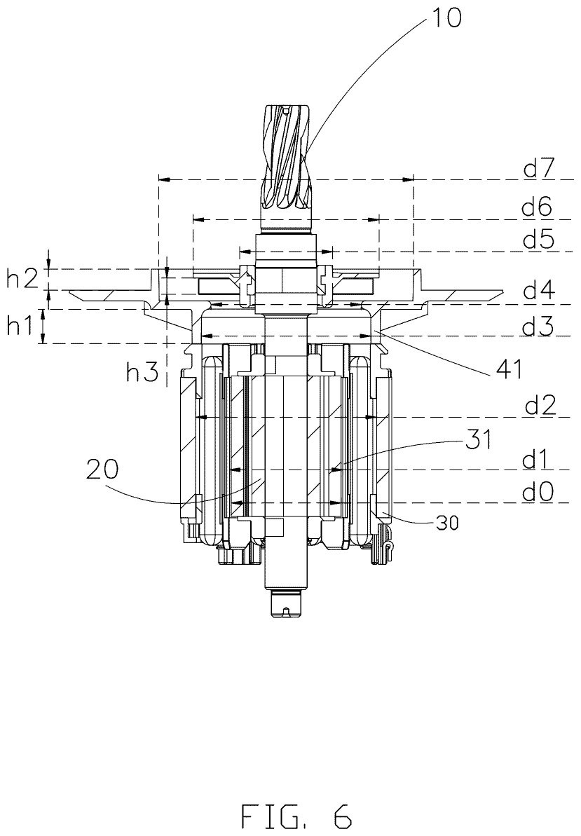

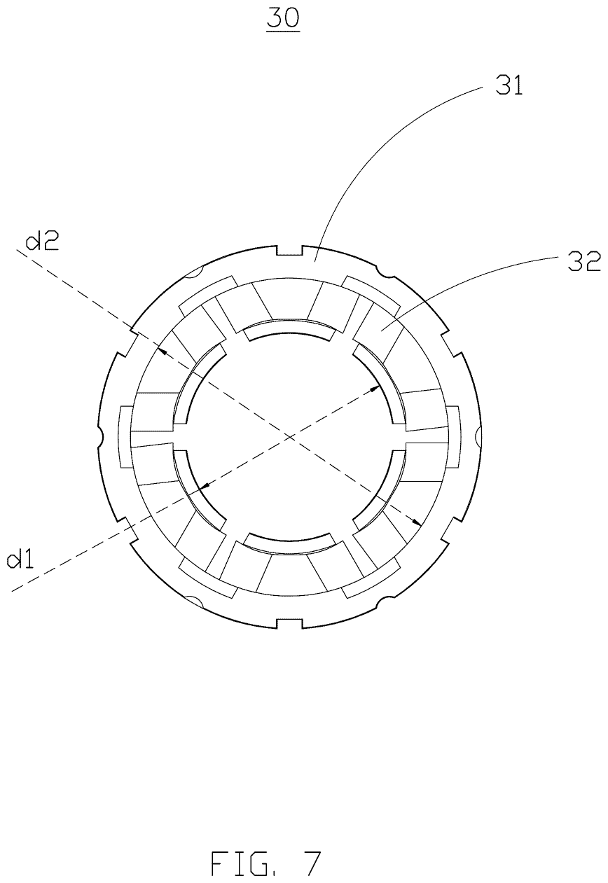

As shown in FIG. 2, FIG. 3, and FIG. 6, the motor 100 includes a shaft 10 extending axially, an inner rotor 20 fixed on an outer circumference of the shaft 10, an outer stator 30 sleeved outside the inner rotor 20, an air-guiding cover 40 setting on the shaft 10, a fan 50 mounted on the shaft 10, and an end plate 60. As shown in FIG. 6, the inner rotor 20 is located between the shaft 10 and the outer stator 30. As shown in FIG. 7, the outer stator 30 includes a stator core 31 and a winding 32 sleeved outside the inner rotor 20. The fan 50 rotates with the shaft 10 to generate airflow. Installing an air-guiding cover 40 can improve the heat dissipation performance of the motor 100, and the air-guiding cover 40 includes a first air-guiding ring 41 located at an axial rear end and a second air-guiding ring 42 located at an axial front end. The first air-guiding ring 41 has a first volute portion 411 and the second air-guiding ring 42 has a second volute portion 421. Setting the fan 50 inside the second volute portion 421 helps with heat dissipation.

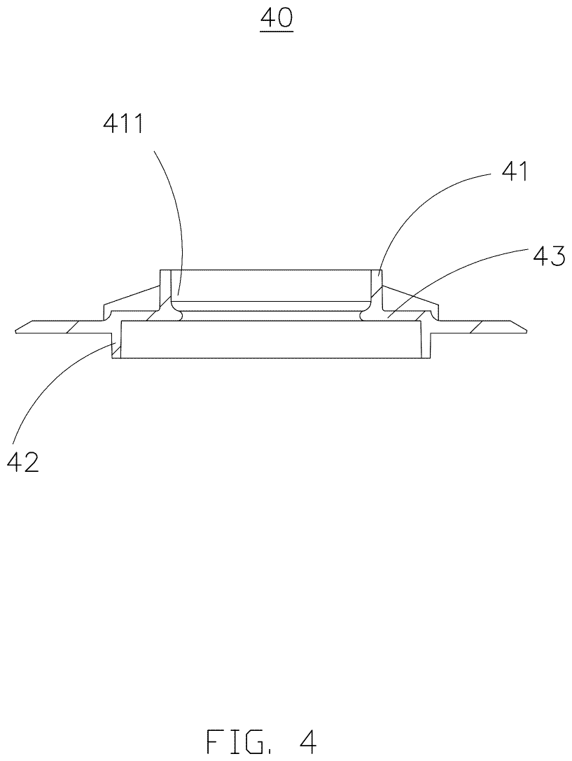

Please refer to FIG. 3 and FIG. 4, the air-guiding cover 40 has an air-guiding plate 43 connected to both the first air-guiding ring 41 and the second air-guiding ring 42. The air-guiding plate 43 is connected between the first air-guiding ring 41 and the second air-guiding ring 42. The air-guiding plate 43 defines a first opening 431 for the shaft 10 to pass through. The first opening 431 has an inner diameter d4 of the air-guiding plate. The air-guiding cover 40 further includes an extended edge 45 that protrudes circumferentially along the air-guiding plate 43 on an inner side of the second air-guiding ring 42. The extended edge 45 protrudes outward with two protrusions 451 perpendicular to an axial direction of the shaft 10. The protrusions 451 are in the casing 80 for positioning of the air-guiding ring. The second air-guiding ring 42 defines a second opening 44 to conduct airflow. The end plate 60 is located on an end side of the outer stator 30 facing the air-guiding cover 40. The first air-guiding ring 41 has a first volute portion 411 to conduct air flow, and an outer edge of the first air-guiding ring 41 abuts against the end plate 60. An inner side of the first air-guiding ring 41 is in a circular arc shape, which can prevent the air flow on the inlet side from directly colliding with the air-guiding plate 43 of the air-guiding cover 40, causing a loss of air flow velocity, and can improve the heat dissipation effect.

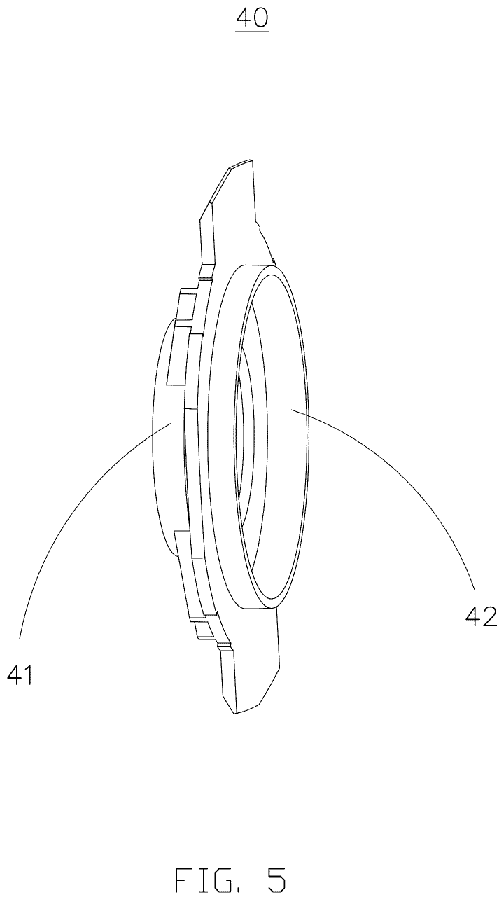

Please refer to FIG. 5, which is another embodiment of the air-guiding cover of the present disclosure. It can be seen that the second air-guiding ring 42 is circular, or it may not define any second opening 44. In some embodiments, the second air-guiding ring 42 has a second opening 44 to conduct air flow and have better heat dissipation effect.

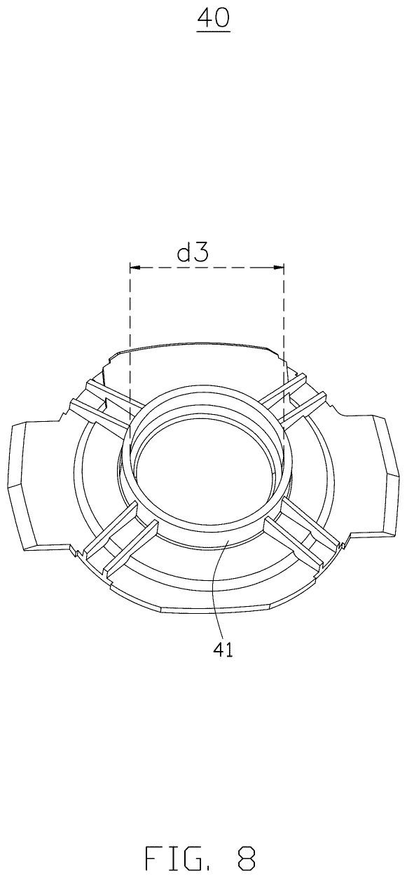

Please refer to FIG. 6, FIG. 7, and FIG. 8, in one embodiment of the present disclosure, the first air-guiding ring 41 has an inner diameter d3, the outer stator 30 has a first stator inner diameter d1, the outer stator 30 has a second stator inner diameter d2, the inner diameter d3 of the first air-guiding ring 41 is 40.1 mm, and the first stator inner diameter d1 of the outer stator 30 is 26.8 mm. In embodiment of the present disclosure, the inner diameter d3 of the first air-guiding ring 41 is such as but not limited to 35 mm, 38 mm, 40 mm, 44.5 mm, 48 mm, 50 mm, and the first stator inner diameter d1 of the outer stator 30 is such as but not limited to 24 mm, 25.5 mm, 27 mm, 29 mm, 30 mm, 35 mm, 40 mm. The present disclosure has been found through research that when the inner diameter d3 of the first air-guiding ring 41 is greater than or equal to the inner diameter d1 of the outer stator, airflow between the outer stator 30 and the power tool casing 80 is not easy to enter between the first air-guiding ring 41 and the power tool casing 80, and the heat dissipation effect is good. Compared with the comparative example where the inner diameter d3 of the first air-guiding ring is 40.1 mm, the first stator inner diameter d1 of the outer stator 30 is 41 mm, and airflow passing through the fan can increase by at least 10%.

The cooling fan is a very important component in the motor, and the performance of the fan directly affects the heat dissipation ability of the motor, thereby affecting lifetime of the motor. Most of the blades of the cooling fan are free form curve surfaces, and other parts will also be designed with different structures according to actual working conditions. There are two types of cooling fans of the electric motor: thrust type and centrifugal type. Spiral fans belong to thrust type, while straight blades are centrifugal type. The air of a thrust type fan blows longitudinally, acting on an end cover of the motor and rebounding back, which has poor heat dissipation effect on the motor casing. The air of a centrifugal type fan radiates in all directions, acting on arc-shaped tail cover of the motor and flowing towards the heat dissipation ribs of the motor casing. It has a good heat dissipation effect on the motor casing, but it will increase the motor volume and cost. In the disclosure, in some embodiments, the fan 50 is selected to be a centrifugal type fan.

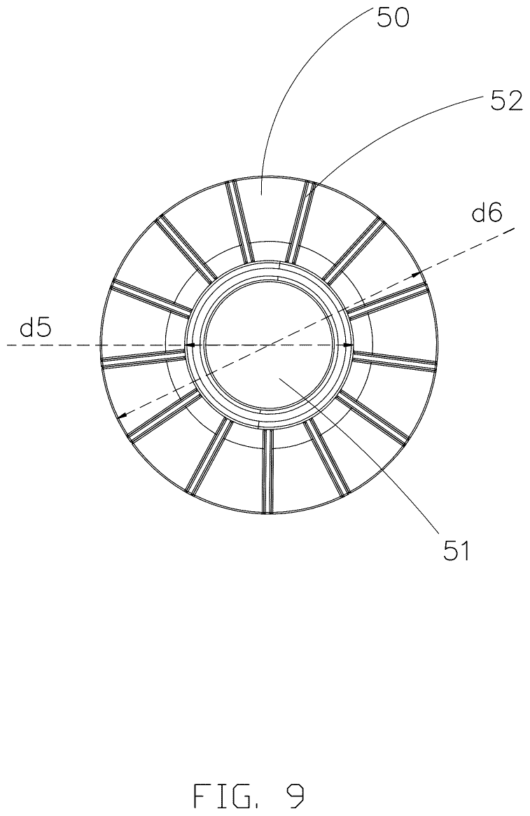

As shown in FIG. 9, the fan 50 has a hub 51 driven by the shaft 10 and several blades 52 radially protruding outward from an outer surface of the hub 51. The hub 51 has a hub diameter d5, and the fan 50 has a fan diameter d6. The fan diameter d6 is roughly the same as the second inner diameter d2 of the stator. In the present disclosure, a ratio of the hub diameter d5 to the fan diameter d6 is defined as a hub ratio. The rotation of fan 50 generates the air flow required for motor heat dissipation, which also becomes the motor load and has a significant impact on motor efficiency. By extensive experiments and research, researchers of the present disclosure have found that when the hub ratio is less than or equal to 0.5, and the hub ratio is greater than or equal to 0.2, the heat dissipation problem can be improved. In the embodiment of the present disclosure, the hub diameter d5 is 22 mm, and the fan diameter d6 is 44 mm. Of course, in the embodiments of the present disclosure, the hub diameter d5 is not limited to 22 mm, the hub diameter d5 is such as but not limited to 20 mm, 21 mm, 23 mm, 25 mm, 28 mm, 30 mm, and the fan diameter d6 is such as but not limited to 30 mm, 45 mm, 48 mm, 50 mm, 54 mm, 56 mm, 60 mm.

The hub ratio is too small. For example, when the hub ratio is 0.1 in the comparison example, inlet air at the blade root is not enough to cool the bottom of the winding coil, causing a temperature of the winding coil increase more than 5% and damaging the motor. When the hub ratio is less than or equal to 0.5, as in the actual implementation example when the hub ratio is 0.3, compared to a fan with a hub ratio greater than 0.5, as in the comparison example when the hub ratio is 0.7, the implementation example can ensure that the inlet air at the blade root is sufficient to cool the bottom of the winding, reducing the temperature of winding by more than 3%.

As shown in FIG. 6, the inner rotor has a rotor outer diameter d0. In embodiments of the present disclosure, the rotor outer diameter d0 is, for example, but not limited to 20 mm, 21 mm, 22 mm, 23 mm, 25 mm, 28 mm, 30 mm. In order to improve the heat dissipation effect, by a large number of creative experiments, it was found that when the hub diameter d5 is less than or equal to the rotor outer diameter d0, as in one embodiment, the hub diameter d5 is 23 mm, and the rotor outer diameter d0 is 26 mm, the air flow between the outer stator 30 and the inner rotor 20 can completely enter into the fan 50. Compared with the hub diameter d5 being greater than the rotor outer diameter d0, as in the comparative example, the hub diameter d5 is 40 mm, and the rotor outer diameter d0 is 35 mm, the heat dissipation effect of the present embodiment is good, which can increase the motor heat dissipation flow by 5%.

Furthermore, the second air-guiding ring 42 has an axial height h2, and the blade 52 has a blade height h3. In embodiments of the present disclosure, the axial height h2 of the second air-guiding ring 42 is 5 mm, and the blade height h3 of the blade 52 is 3.9 mm. In some embodiments of the present disclosure, the axial height h2 of the second air-guiding ring 42 is, for example, but not limited to 4 mm, 4.5 mm, 5.2 mm, 6 mm, 8 mm, and 10 mm. The blade height h3 of the blade 52 is, for example, but not limited to 2 mm, 2.5 mm, 3 mm, 3.4 mm, 4 mm, 5 mm, and 6 mm. The present disclosure finds through research that the axial height h2 of the second air-guiding ring 42 is greater than or equal to the blade height h3. For example, compared to the axial height h2 of the second air-guiding ring 42 in the comparative example, which is 3 mm, the blade height h3 of the blade 52 is 3.9 mm. At this time, it can be ensured that the blade 52 is completely located in the second volute portion 421 of the second air-guiding ring 42, which is conducive to controlling the airflow direction and has good heat dissipation effect.

Please refer to FIG. 3 and FIG. 6, the air-guiding cover 40 has the air-guiding plate 43 connected to the first air-guiding ring 41 and the second air-guiding ring 42. The air-guiding plate 43 has an inner diameter d4. The inner diameter d4 is such as but not limited to 30 mm, 33 mm, 35.5 mm, 36.5 mm, 37.2 mm, 39.6 mm, 40.8 mm, 45 mm. In an embodiment of the present disclosure, the inner diameter d4 of the air-guiding plate is 35.5 mm. After making a lot of creative work, the inventor unexpectedly discovered that when the inner diameter d4 of the air-guiding plate is greater than the diameter d6 of the fan, for example, if the inner diameter d4 of the air-guiding plate is 40 mm and the diameter d6 of the fan is 35 mm, it will cause airflow crossing, and the air-guiding cover will not play a guiding role. If the inner diameter d4 of the air-guiding plate is too little, for example, the inner diameter d4 of the air-guiding plate is less than half of a sum of the hub diameter d5 and the fan diameter d6. For example, if the inner diameter d4 of the air-guiding plate is 20 mm, the hub diameter d5 is 28 mm, and the fan diameter d6 is 50 mm, it will cause the air flow resistance to be too strong, resulting in a decrease of more than 5% in the heat dissipation flow of the entire power tool. Only when the inner diameter d4 of the air-guiding plate is greater than or equal to half of the sum of the hub diameter d5 and the fan diameter d6, and the inner diameter d4 of the air-guiding plate is less than or equal to the fan diameter d6, for example, the inner diameter d4 of the air-guiding plate is 35.5 mm, the hub diameter d5 is 22 mm, and the fan diameter d6 is 44 mm, the heat dissipation effect is better, and the motor heat dissipation flow rate is significantly increased, reaching more than 10%.

As shown in FIG. 6, the first air-guiding ring has an axial height h1. The axial height h1 of the first air-guiding ring is, for example, but not limited to 5 mm, 8.2 mm, 10 mm, 11.5 mm, 12.5 mm, 15 mm. In an embodiment of the present disclosure, the axial height h1 of the first air-guiding ring is 8.2 mm. The present inventor has found that the heat dissipation effect is better when a ratio of the axial height h1 of the first air-guiding ring to the inner diameter d4 of the air-guiding plate is less than or equal to 0.5. If the ratio of the axial height h1 of the first air-guiding ring to the inner diameter d4 of the air-guiding plate is too little, for example, the axial height h1 is 5 mm, the inner diameter d4 of the air-guiding plate is 50 mm, and hot air between the winding coils is prone to directly impact wall of the air-guiding cover, increasing flow resistance and causing a local temperature rise of more than 3%. If the ratio of the axial height h1 of the first air-guiding ring to the inner diameter d4 of the air-guiding plate is too great, for example, if the axial height h1 is 18 mm and the inner diameter d4 of the air-guiding plate is 30 mm, then axial flow space inside the first air-guiding ring is too large, which is easy to form a circular vortex area, which is not conducive to the direct flow of hot air into the fan for discharge, and the heat dissipation flow rate of the motor decreases by more than 5%.

In one embodiment, the second air-guiding ring has an inner diameter d7. The inner diameter d7 of the second air-guiding ring is, for example, but not limited to 50 mm, 54.2 mm, 58 mm, 60 mm, 62 mm, 65 mm, 70 mm. In an embodiment of the present disclosure, the inner diameter d7 of the second air-guiding ring is 60.1 mm. After extensive creative work, the present inventor found that the inner diameter d7 of the second air-guiding ring is greater than or equal to a difference between twice of the fan diameter d6 subtracts the inner diameter d4 of the air-guiding plate. That is relationship between the inner diameter d7 of the second air-guiding ring, the fan diameter d6, and the inner diameter d4 of the air-guiding plate follows the following formula: d7≥2d6−d4. For example, when the inner diameter d7 of the second air-guiding ring is 60.1 mm, the fan diameter d6 is 44 mm, and the inner diameter d4 of the air-guiding plate is 35.5 mm, the total pressure efficiency is greatly improved. When the inner diameter d7 of the second air-guiding ring is less than the difference between twice of the diameter d6 of the fan and the inner diameter d4 of the air-guiding plate, for example, when the inner diameter d7 of the second air-guiding ring is 40 mm, the fan diameter d6 is 44 mm, and the inner diameter d4 of the air-guiding plate is 35.5 mm, and the fan 50 cannot obtain sufficient expansion pressure for air outlet. Furthermore, at this time, the flow rate is too low, the static pressure is not high, and the air outlet resistance is too high, resulting in poor air outlet. Compared to comparative example of the latter, the implementation example of the former increases the heat dissipation flow of the motor by at least 10% and reduces the winding temperature rise by more than 2° C. because the fan outlet airflow can obtain sufficient static pressure to overcome flow resistance.

By limiting the parameters, when the motor starts working, the blades 52 located in the second volute portion 421 will be driven to rotate at high speed. Due to the setting of the air-guiding cover 40, the heat dissipation effect on the motor 100 is enhanced, and the noise generated by the rotation of the motor 100 can also be reduced.

In the description of this specification, the reference terms “one embodiment”, “some embodiments”, “illustrative embodiments”, “examples”, “specific examples”, or “some examples” refer to specific features, structures, materials, or features described in conjunction with the embodiments or examples included in at least one embodiment or example of the present disclosure. In this manual, the illustrative expressions of the above terms may not necessarily refer to the same embodiments or examples. Moreover, the specific features, structures, materials, or features described can be combined in an appropriate manner in any one or more embodiments or examples.

Although embodiments of the present disclosure have been shown and described, those skilled in the art may understand that various changes, modifications, substitutions, and variations can be made to these embodiments without departing from the principles and objectives of the present disclosure. The scope of the present disclosure is limited by the claims and their equivalents.

1. A motor comprising:
a shaft extending in an axial direction;
an inner rotor fixed on the shaft;
an outer stator sleeved on an outer circumference of the inner rotor; and
a fan setting on the shaft, the fan rotating with the shaft to generate airflow to cool the outer stator;
wherein the motor further comprises an air-guiding cover, the air-guiding cover comprises a first air-guiding ring and a second air-guiding ring arranged along the axial direction of the shaft, wherein the first air-guiding ring is located between the outer stator and the second air-guiding ring;
the fan is located within the second air-guiding ring, and the first air-guiding ring has an inner diameter d3 of the first air-guiding ring, the outer stator has a first inner diameter d1, and the inner diameter d3 of the first air-guiding ring is greater than or equal to the first inner diameter d1 of the outer stator.

2. The motor of claim 1, wherein the fan comprises a hub driven by the shaft and a plurality of blades radially protruding outward from a peripheral edge of the hub, the plurality of blades surrounds the hub;
the hub has a hub diameter d5, the inner rotor has a rotor outer diameter d0, and the hub diameter d5 is less than or equal to the rotor outer diameter d0.

3. The motor of claim 2, wherein the second air-guiding ring has an axial height h2, the blade has a blade height h3, and the axial height h2 of the second air-guiding ring is greater than or equal to the blade height h3 of the blade.

4. The motor of claim 3, wherein the fan has a fan diameter d6, and a ratio of the hub diameter d5 to the fan diameter d6 is less than or equal to 0.5, and a ratio of the hub diameter d5 to the fan diameter d6 is greater than or equal to 0.2.

5. The motor of claim 4, wherein the air-guiding cover comprises an air-guiding plate located between the first air-guiding ring and the second air-guiding ring, and the air-guiding plate defines a first opening for the shaft to pass through;
the first opening has an inner diameter d4 of the air-guiding plate, wherein a relationship between the inner diameter d4 of the air-guiding plate, the diameter d5 of the hub, and the diameter d6 of the fan follows following formula: 0.5(d5+d6)≤d4≤d6.

6. The motor of claim 5, wherein the first air-guiding ring has an axial height h1, and a ratio of the axial height h1 of the first air-guiding ring to the inner diameter d4 of the air-guiding plate is less than or equal to 0.5 and greater than or equal to 0.1.

7. The motor of claim 5, wherein the second air-guiding ring has an inner diameter d7 of the second air-guiding ring, wherein a relationship between the inner diameter d7 of the second air-guiding ring, the fan diameter d6, and the inner diameter d4 of the air-guiding plate follows following formula: d7≥2d6−d7.

8. The motor of claim 5, wherein the air-guiding cover comprises an extended edge that protrudes outward along a circumference of the air-guiding plate, and the extended edge protrudes outward with two protrusions perpendicular to the axial direction of the shaft.

9. The motor of claim 1, wherein the motor further comprises a plurality of end plates, the plurality of end plates are on an end side of the outer stator facing the air-guiding cover, the inner side of the first air-guiding ring is arc-shaped and an outer edge of the first air-guiding ring abuts against the end plate, and the first air-guiding ring also has a first volute portion to conduct air flow.

10. The motor of claim 9, wherein the second air-guiding ring comprises a second volute portion that accommodates the fan and a second opening located in the circumferential direction of the second air-guiding ring, the second opening is used to conduct airflow.

11. A power tool comprising:
a casing; and
a motor in the casing, the motor comprising:
a shaft extending in an axial direction;
an inner rotor fixed on the shaft;
an outer stator sleeved on an outer circumference of the inner rotor; and
a fan setting on the shaft, the fan rotating with the shaft to generate airflow to cool the outer stator,
wherein the motor further comprises an air-guiding cover, the air-guiding cover comprises a first air-guiding ring and a second air-guiding ring arranged along the axial direction of the shaft, wherein the first air-guiding ring is located between the outer stator and the second air-guiding ring;
the fan is located within the second air-guiding ring, and the first air-guiding ring has an inner diameter d3 of the first air-guiding ring, the outer stator has a first inner diameter d1, and the inner diameter d3 of the first air-guiding ring is greater than or equal to the first inner diameter d1 of the outer stator.

12. The power tool of claim 11, wherein the fan comprises a hub driven by the shaft and a plurality of blades radially protruding outward from a peripheral edge of the hub, the plurality of blades surrounds the hub;
the hub has a hub diameter d5, the inner rotor has a rotor outer diameter d0, and the hub diameter d5 is less than or equal to the rotor outer diameter d0.

13. The power tool of claim 12, wherein the second air-guiding ring has an axial height h2, the blade has a blade height h3, and the axial height h2 of the second air-guiding ring is greater than or equal to the blade height h3 of the blade.

14. The power tool of claim 13, wherein the fan has a fan diameter d6, and a ratio of the hub diameter d5 to the fan diameter d6 is less than or equal to 0.5, and a ratio of the hub diameter d5 to the fan diameter d6 is greater than or equal to 0.2.

15. The power tool of claim 14, wherein the air-guiding cover comprises an air-guiding plate located between the first air-guiding ring and the second air-guiding ring, and the air-guiding plate defines a first opening for the shaft to pass through;
the first opening has an inner diameter d4 of the air-guiding plate, wherein a relationship between the inner diameter d4 of the air-guiding plate, the diameter d5 of the hub, and the diameter d6 of the fan follows following formula: 0.5(d5+d6)≤d4≤d6.

16. The power tool of claim 15, wherein the first air-guiding ring has an axial height h1, and a ratio of the axial height h1 of the first air-guiding ring to the inner diameter d4 of the air-guiding plate is less than or equal to 0.5 and greater than or equal to 0.1.

17. The power tool of claim 15, wherein the second air-guiding ring has an inner diameter d7 of the second air-guiding ring, wherein a relationship between the inner diameter d7 of the second air-guiding ring, the fan diameter d6, and the inner diameter d4 of the air-guiding plate follows following formula: d7≥2d6−d7.

18. The power tool of claim 15, wherein the air-guiding cover comprises an extended edge that protrudes outward along a circumference of the air-guiding plate, and the extended edge protrudes outward with two protrusions perpendicular to the axial direction of the shaft.

19. The power tool of claim 11, wherein the motor further comprises a plurality of end plates, the plurality of end plates are on an end side of the outer stator facing the air-guiding cover, the inner side of the first air-guiding ring is arc-shaped and an outer edge of the first air-guiding ring abuts against the end plate, and the first air-guiding ring also has a first volute portion to conduct air flow.

20. The power tool of claim 19, wherein the second air-guiding ring comprises a second volute portion that accommodates the fan and a second opening located in the circumferential direction of the second air-guiding ring, the second opening is used to conduct airflow.
